(19) United States
(12) Patent Application Publication
(10) Pub. No.: US 2011/0000672 A1
(43) Pub. Date: Jan. 6, 2011

(54) Clay Stabilization with Nanoparticles

(75) Inventor: Tianping Huang, Spring, TX (US)

Correspondence Address: Mossman, Kumar and Tyler, PC, P.O. Box 421239, Houston, TX, 77242, US

(73) Assignee: BAKER HUGHES INCORPORATED, Houston, TX (US)

(21) Appl. No.: 12/277,825

(22) Filed: Nov. 25, 2008

Related U.S. Application Data
(63) Continuation-in-part of application No. 11/931,706, filed on Oct. 31, 2007.
Application No. 11/931,706 is a continuation-in-part of application No. 11/931,501, filed on Oct. 31, 2007, now Pat. No. 7,721,803.

(51) Int. Cl. E21B 43/26; C09K 8/84

(52) U.S. Cl. 166/308.1; 507/269

(57) ABSTRACT

A treating fluid may contain an effective amount of a particulate additive to stabilize clays, such as clays in a subterranean formation, by inhibiting or preventing them from swelling and/or migrating, where the particulate additive is an alkaline earth metal oxide, alkaline earth metal hydroxide, alkali metal oxide, alkali metal hydroxide, transition metal oxide, transition metal hydroxide, post-transition metal oxide, post-transition metal hydroxide, piezoelectric crystal, and/or pyroelectric crystal. The particle size of the magnesium oxide or other agent may be nanometer scale, which scale may provide unique particle charges that help stabilize the clays. These treating fluids may be used as treatment fluids for subterranean hydrocarbon formations, such as in hydraulic fracturing, completion fluids, gravel packing fluids and fluid loss pills. The carrier fluid used in the treating fluid may be aqueous, brine, alcoholic or hydrocarbon-based.

### CROSS-REFERENCES TO RELATED APPLICATIONS

This application is a continuation-in-part application from U.S. Ser. No. 11/931,706 filed Oct. 31, 2007 and is a continuation-in-part application from U.S. Ser. No. 11/931,501 also filed Oct. 31, 2007.

### TECHNICAL FIELD

The present invention relates to methods and compositions for stabilizing clays during hydrocarbon recovery operations, and more particularly relates, in one non-limiting embodiment, to methods and compositions for stabilizing clays in subterranean formations by inhibiting or preventing them from swelling using nano-sized particles.

### BACKGROUND

Production of petroleum hydrocarbons is often troubled by the presence of clays and other fines capable of migrating in the formation. Normally, these fines, including the clays, are quiescent, causing no obstruction of flow to the wellbore via the capillary system of the formation. However, when the fines are disturbed, they begin to migrate in the production stream and, too frequently, they encounter a constriction in the capillary where they bridge off and severely diminish the flow rate.

A phenomenon that disturbs the quiescent clays and fines is often the introduction of water foreign to the formation. The foreign water is often fresh or relatively fresh water compared to the native formation brine. The water is frequently intentionally introduced such as for purposes of hydraulic fracturing of the formation rock to increase production rates. Hydraulic fracturing is a method of using pump rate and hydraulic pressure to fracture or crack a subterranean formation, typically with an aqueous fluid. Once the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons. In any event, the change in the water can cause clays to disperse from their repository or come loose from adhesion to capillary walls.

Sometimes the loss of permeability is due to clay swelling with relatively fresh water without migration of the clay particles, although, often clay swelling is accompanied by migration of clays and fines. Sometimes non-swelling clays can respond to the foreign water and begin to migrate. It is believed that swelling clays are the major mechanism of fines migration and/or swelling, because when formation cores are analyzed, the presence of swelling clays are an excellent indicator that the formation will be sensitive to foreign water intrusion, while the presence of non-swelling clays only is inconclusive.

Generally, swelling clays are in the smectic group including clay minerals such as montmorillonite, beidellite, nontronite, saponite, hectorite, and sauconite. Of these, montmorillonite is the clay mineral found most commonly in formation core analysis. Montmorillonite is commonly associated with clay minerals known as mixed-layer clays.

Migrating fines include a host of clay and other minerals in minute particle size, for example, feldspars, fine silica, kaolinite, allophane, biotite, talc, illite, chlorite and the swelling clays themselves. Further information is found in U.S. Pat. No. 5,160,642, incorporated by reference herein in its entirety.

Clays can also cause trouble in areas other than permeability reduction. When they are a component in shales, sandstones, or other formations, contact with a foreign water or at times with any water can cause the formation to lose strength or even disintegrate. This is a problem in building foundations, road beds, drilling wells, enhanced oil recovery and any situation where the formation strength is important.

There have been numerous attempts to control the ill effects of water on clay and/or other fines. These efforts have been principally in the oil exploration and production industry. One idea is to convert the clay from the swelling sodium form or the more rare swelling lithium form to another cation form which does not swell as much.

Example cations that form relatively non-swelling clays are potassium, calcium, ammonium and hydrogen ions, such as from potassium chloride, ammonium chloride and the like. Thus, conventional clay stabilizers are inorganic salts, such as KCl, NH₄Cl, and cationic organic polymers. When a solution of these cations, mixed or individually, flows past a clay mineral, they readily replace the sodium ion and the clay is transformed to a relatively non-swelling form. The use of acid, potassium, calcium, or ammonium ions to exchange for sodium ion has been successful in preventing damage to formations susceptible to plugging or disintegrating due to clays in their compositions. However, these conventional clay stabilizers are efficient with respect to negatively charged clays, but not with respect to non-charged clays.

Another approach teaches the use of quaternary salts of copolymers of an unsaturated acid or anhydride (including maleic anhydride) and another unsaturated compound (hydrocarbon, ester, or either), in a ratio of 1:1 to 1:4. While these materials are operable, they do not provide as high a degree of stabilization as is desired.

An alternative technique uses two polymeric additives, one that is a flocculant at low concentrations, where the other prevents hydration and disintegration of clay-rich formations. Water-soluble, organosilicone compounds have also been used to reduce the mobility of clay and other siliceous fines in clayish formations.

U.S. Pat. No. 5,160,642 to Schield, et al. instructs that a clayish formation, such as encountered in rock surrounding an oil wellbore, is stabilized with a quaternary ammonium salt of an imide of polymaleic anhydride. Further there is U.S. Pat. No. 7,328,745 to Poelker, et al. that teaches a clayish subterranean formation may be stabilized with relatively high molecular weight polyamine salts of an imide of polymaleic anhydride. The salts may be unneutralized or partially neutralized. These methods are particularly relevant to hydraulic fracturing fluids used in enhanced oil recovery. The compositions are made in the presence of a reactive solvent, such as a polyalkylene glycol, e.g. polyethylene glycol. The latter are more environmentally friendly than some current technology.

Accordingly, it would be desirable to provide a clay stabilization composition and method that would provide a high degree of stabilization of clays, particularly those in subterranean formations.

### SUMMARY

There is provided, in one form, a method for stabilizing clays that involves introducing a treating fluid into a subterranean formation containing clays. The treating fluid includes a base fluid, and an amount of a particulate additive effective to stabilize the clays. The particulate additive may have a mean particle size of 100 nm or less, and may include, but not necessarily be limited to, alkaline earth metal oxides, alkaline earth metal hydroxides, alkali metal oxides, alkali metal hydroxides, transition metal oxides, transition metal hydroxides, post-transition metal oxides, post-transition metal hydroxides, piezoelectric crystals, and/or pyroelectric crystals. Consequently, the clays in the formation are inhibited from expansion as compared with introducing an identical fluid into the subterranean formation absent the particulate additive.

There is additionally provided in another non-limiting embodiment a method for stabilizing clays that involves introducing a treating fluid into a subterranean formation containing clays. The treating fluid may include an aqueous base fluid, and an amount of a particulate additive that is effective to stabilize the clays. The particulate additive may have a mean particle size of 100 nm or less. Again, suitable particulate additives include, but are not necessarily limited to, alkaline earth metal oxides, alkaline earth metal hydroxides, alkali metal oxides, alkali metal hydroxides, transition metal oxides, transition metal hydroxides, post-transition metal oxides, post-transition metal hydroxides, piezoelectric crystals, and/or pyroelectric crystals. In the particulate additive, a suitable alkaline earth metal may be magnesium, calcium, strontium, and/or barium. A suitable alkali metal may be lithium, sodium, and/or potassium. A suitable transition metal may be titanium and/or zinc. A suitable post-transition metal may be aluminum. Mixtures of these particulate additives are also suitable. The treated clays in the formation are thus inhibited from expansion as compared with introducing an identical fluid into the subterranean formation absent the particulate additive.

The particulate additives, also referred to herein as nano-sized particles or nanoparticles (e.g. MgO and/or Mg(OH)₂, and the like), appear to bind to, associate with or flocculate clays and clay particles, including charged and non-charged particles, both expanding clays and non-expanding clays. Due to at least in part to their small size, the surface forces (like van der Waals and electrostatic forces) of nanoparticles help them associate, group or flocculate the clays together in larger collections, associations or agglomerations. Such groupings or associations help fix the clays in place and keep them from swelling and/or moving. In many cases, the ability of the treating fluids to stabilize clays may be improved by use of nano-sized particulate additives that may be much smaller than the pores and pore-throat passages within a hydrocarbon reservoir, thereby being non-pore plugging particles that are much less damaging to the reservoir permeability than the clays themselves. This smaller size permits the nanoparticles to readily enter the formation, and then stabilize the clays in place so that both the clays and the nanoparticles remain in the formation and do not travel as far—or at least are restrained to the point that damage to the near-wellbore region of the reservoir is minimized.

The addition of alkaline earth metal oxides, such as magnesium oxide; alkaline earth metal hydroxides, such as calcium hydroxide; transition metal oxides, such as titanium oxide and zinc oxide; transition metal hydroxides; post-transition metal oxides, such as aluminum oxide; post-transition metal hydroxides; piezoelectric crystals and/or pyroelectric crystals such as ZnO and AlPO₄, to an aqueous fluid, or solvent-based fluid such as glycol, or oil-base fluid which is then introduced into a subterranean formation is expected to prevent or inhibit the swelling of clays in the subterranean formation to stabilize them, and prevent or minimize the damage they may cause to the formation permeability.

### BRIEF DESCRIPTION OF THE DRAWINGS

FIG. 1A is the left side of a photograph of a beaker of 0.5% by weight (bw) natural bentonite in 50 mls deionized (DI) water to simulate a swelling clay in water, immediately after stirring for two minutes;

FIG. 1B is the right side of a photograph of a beaker of 0.5% bw natural bentonite in 50 mls DI water to simulate a swelling clay in water, as in FIG. 1A, but also containing 0.5% bw MgO particles (crystallite size≦8 nm; specific surface area≧230 m²/g) immediately after stirring for two minutes;

FIG. 2A is the left side of a photograph showing the beaker in FIG. 1A 20 minutes after stirring has ceased;

FIG. 2B is the right side of a photograph showing the beaker in FIG. 1B 20 minutes after stirring has ceased;

FIG. 3A is the left side of a photograph showing the beaker in FIG. 1A 60 minutes after stirring has ceased;

FIG. 3B is the right side of a photograph showing the beaker in FIG. 1B 60 minutes after stirring has ceased;

FIG. 4 is a graph presenting a pressure drop comparison as a function of time for 20/40 mesh (850/425 micron) sand packs at 10 ml/min of 5% KCl for sand only (curve with squares), the same size sand with 1% bw (of 20/40 mesh sand) illite and 1% bw (of 20/40 mesh sand) bentonite clays (curve with diamonds), and then the same size sand with 1% bw illite, 1% bw bentonite clays and 0.4% bw (of 20/40 mesh sand) nanoparticles (curve with triangles); and

FIG. 5 is a graph presenting a pressure drop comparison as a function of time for 20/40 mesh (850/425 micron) sand packs at 10 ml/min of 5% KCl for sand only (curve with diamonds), sand with 2% bw (of 20/40 mesh sand) illite clays (curve with squares), then the same size sand with 2% bw illite and 0.4% bw (of 20/40 mesh sand) nanoparticles (curve with stars), and 5% KCl with 2% CSM-38 clay control additive from CESI Chemical flowing through the sand with 2% bw (of 20/40 mesh sand) illite clays (curve with circles).

### DETAILED DESCRIPTION

It has been discovered that nanoparticles (nanometer-sized particles) are useful for subterranean formation clay stabilization. Without wishing to be limited to any particular explanation or mechanism, it is theorized that the surface forces of the nanoparticles, at their scale, such as van der Waals forces and electrostatic forces, stabilize local clay particles from expanding and moving.

Clay swelling and/or migrating have been troublesome during well drilling and completion, oil and gas production, as well as during many oil and gas recovery operations including, but not necessarily limited to, acidizing, fracturing, gravel packing, secondary and tertiary recovery operations, and the like. The clays most frequently found in the underground oil and gas bearing formation include bentonite (montmorillonite) group, illite group, kaolinite group, chlorite group, and the mixtures of them.

It has been discovered that nano-sized particles like magnesium oxide (MgO) may be used to stabilize clays in subterranean hydrocarbon formations to inhibit, restrain or prevent them from swelling and/or migrating to near-wellbore regions to choke or damage the production of hydrocarbons. Some nano-sized particles, also called nanoparticles herein, not only have high surface areas compared to their small sizes, but also have relatively high surface charges that permit them to associate with or connect other particles together, including other charged particles, but also other non-charged particles. In one non-limiting explanation, these associations or connections between the clays and the nanosized particles are due to electrical attractions and other intermolecular forces or effects.

As will be shown, laboratory tests have demonstrated that relatively small amounts of MgO nanoparticles can stabilize dispersed clay particles. Other nanoparticles such as ZnO, Al₂O₃, zirconium dioxide (ZrO₂), TiO₂, cobalt (II) oxide (CoO), nickel (II) oxide (NiO), and pyroelectric and piezoelectric crystals may also be used in the methods and compositions herein. The nanoparticles may be pumped with a carrier fluid downhole deep within the formation to contact and treat the clays.

In more detail, nano-sized particles of alkaline earth metal oxides, alkaline earth metal hydroxides, alkali metal oxides, alkali metal hydroxides, transition metal oxides, transition metal hydroxides, post-transition metal oxides, and post-transition metal hydroxides, piezoelectric crystals, pyroelectric crystals, and mixtures thereof have been discovered to have particular advantages for stabilizing clays and inhibiting or preventing their undesired migration, rather than allowing them to damage production of the near-wellbore region of the reservoir.

In particular, magnesium oxide particles and powders have been suitably used to stabilize clays herein. However, it will be appreciated that although MgO particles are noted throughout the description herein as one representative or suitable type of alkaline earth metal oxide particle, other alkaline earth metal oxides and/or alkaline earth metal hydroxides and/or transition metal oxides, transition metal hydroxides, post-transition metal oxides, and post-transition metal hydroxides, piezoelectric crystals, pyroelectric crystals, may be used in the methods and compositions herein. Additionally, the alkali metal oxides and/or hydroxides may be used alone or in combination with the alkaline earth metal oxides and hydroxides, and/or together with one or more transition metal oxide, transition metal hydroxide, post-transition metal oxide, post-transition metal hydroxide, piezoelectric crystal, and pyroelectric crystal.

By “post-transition metal” is meant one or more of aluminum, gallium, indium, tin, thallium, lead and bismuth. In another non-limiting embodiment herein, the nano-sized particles are oxides and hydroxides of elements of Groups IA, IIA, IVA, IIB and IIIB of the previous IUPAC American Group notation. These elements include, but are not necessarily limited to, Na, K, Mg, Ca, Ti, Zn and/or Al.

The nano-sized particulate additives herein may also be piezoelectric crystal particles (which include pyroelectric crystal particles). Pyroelectric crystals generate electrical charges when heated and piezoelectric crystals generate electrical charges when squeezed, compressed or pressed.

In one non-limiting embodiment, specific suitable piezoelectric crystal particles may include, but are not necessarily limited to, ZnO, berlinite (AlPO₄), lithium tantalate (LiTaO₃), gallium orthophosphate (GaPO₄), BaTiO₃, SrTiO₃, PbZrTiO3, KNbO₃, LiNbO₃, LiTaO₃, BiFeO₃, sodium tungstate, Ba₂NaNb₅O₅, Pb₂KNb₅O₁₅, potassium sodium tartrate, tourmaline, topaz and mixtures thereof. The total pyroelectric coefficient of ZnO is −9.4 C/m²K. ZnO and these other crystals are generally not water soluble.

In one non-limiting explanation, when the aqueous carrier fluid mixed with very small pyroelectric crystals, such as nano-sized ZnO, is pumped downhole into underground formations that are under high temperature and/or pressure, the pyroelectric crystals are heated and/or pressed and high surface charges are generated. These surface charges permit the crystal particles to associate, link, connect or otherwise relate the clays together to fixate them together and also to bind or associate them with the surrounding formation surfaces. The association or relation of the clays is thought to be very roughly analogous to the crosslinking of polymer molecules by crosslinkers, in one non-limiting image. No formation damage is expected from the use of the nano-sized particulate additives.

In one non-limiting embodiment, the nano-sized solid particulates and powders useful herein include, but are not necessarily limited to, alkaline earth metal oxides or alkaline earth metal hydroxides, or mixtures thereof. In one non-limiting embodiment, the alkaline earth metal in these additives may include, but are not necessarily limited to, magnesium, calcium, barium, strontium, combinations thereof and the like. In one non-limiting embodiment, MgO may be obtained in high purity of at least 95 wt %, where the balance may be impurities such as Mg(OH)₂, CaO, Ca(OH)₂, SiO₂, Al₂O₃, and the like.

In another non-limiting embodiment, the particle size of the additives and agents ranges between about 1 nanometer independently up to about 500 nanometers. In another non-limiting embodiment, the particle size ranges between about 4 nanometers independently up to about 100 nanometer. In another non-restrictive version, the particles may have a mean particle size of about 100 nm or less, alternatively about 90 nm or less, and in another possible version about 50 nm or less, alternatively 40 nm or less.

The amount of nano-sized particles in the aqueous fluid may range from about 2 to about 300 pounds per thousand gallons (pptg) (about 0.24 to about 36 kg/1000 liters). Alternatively, the lower threshold of the proportion range may be about 10 pptg (about 1.6 kg/1000 liters), while the upper threshold of proportion of the particles may independently be about 50 pptg (about 6 kg/1000 liters) pptg.

The nano-sized particles herein may be added along with the aqueous treating fluids prior to pumping downhole or other application. The aqueous base fluid could be, for example, water, brine, aqueous-based foams or water-alcohol mixtures. The brine base fluid may be any brine, conventional or to be developed which serves as a suitable media for the various concentrate components. As a matter of convenience, in many cases the brine base fluid may be the brine available at the site used in the completion fluid (for completing a well) or other application, for a non-limiting example.

More specifically, and in non-limiting embodiments, the brines may be prepared using salts including, but not necessarily limited to, NaCl, KCl, CaCl₂, MgCl₂, NH₄Cl, CaBr₂, NaBr₂, sodium formate, potassium formate, and other commonly used stimulation and completion brine salts. The concentration of the salts to prepare the brines may be from about 0.5% by weight of water up to near saturation for a given salt in fresh water, such as 10%, 20%, 30% and higher percent salt by weight of water. The brine may be a combination of one or more of the mentioned salts, such as a brine prepared using NaCl and CaCl₂ or NaCl, CaCl₂, and CaBr₂ as non-limiting examples. In application, the nano-sized particulate additives of MgO (or other particulate) may be mixed with the carrier fluids at the surface before they are pumped downhole.

In another non-limiting embodiment, the nano-sized particles herein may be added to a non-aqueous fluid during a treatment. For example, the MgO nanoparticles can be added to a mineral oil or other hydrocarbon as the carrier fluid and then pumped into place downhole. In one non-limiting example the nanoparticles in a non-aqueous fluid can be a pre-pad fluid stage before a hydraulic frac, frac-pack or gravel pack treatment.

While the fluids herein are sometimes described typically herein as having use in fracturing fluids, in which case they will typically contain a conventional proppant, it is expected that they will find utility in completion fluids (which may also contain a salt or easily removed solid), gravel pack fluids, fluid loss pills, lost circulation pills, diverter fluids, foamed fluids, acidizing fluids, water and/or gas control fluids, enhanced oil recovery (i.e. tertiary recovery) fluids, and the like. In the case where the carrier fluid is an acidizing fluid, it also contains an acid. Other stimulation fluids may have different, known stimulating agents. In the case where the carrier fluid is also a gravel pack fluid, the fluid also contains gravel consistent with industry practice. Fluid loss control pills may also contain a salt or easily removed solid.

The base fluid may also contain other conventional additives common to the well service industry such as water wetting surfactants, non-emulsifiers and the like. In another non-restrictive embodiment, the treatment fluid may contain other additives including, but not necessarily limited to, viscosifying agents, other different surfactants, scale inhibitors, scale dissolvers, polymer and biopolymer degradation additives, defoamers, biocides, and other common and/or optional components.

The invention will be further described with respect to the following Examples which are not meant to limit the invention, but rather to further illustrate the various embodiments.

### Example 1

A comparison was conducted between two different fluids of the following compositions:
Fluid A: 0.5% bw natural bentonite in DI water
Fluid B: 0.5% bw natural bentonite in DI water, including 0.5% bw MgO nanoparticles (crystallite size≦8 nm; specific surface area≧230 m²/g).
   Fluid A simulates a conventional aqueous fluid where clay particles are dispersed therein. Fluid B is Fluid A additionally with nanoparticles of the methods and compositions, as defined above.

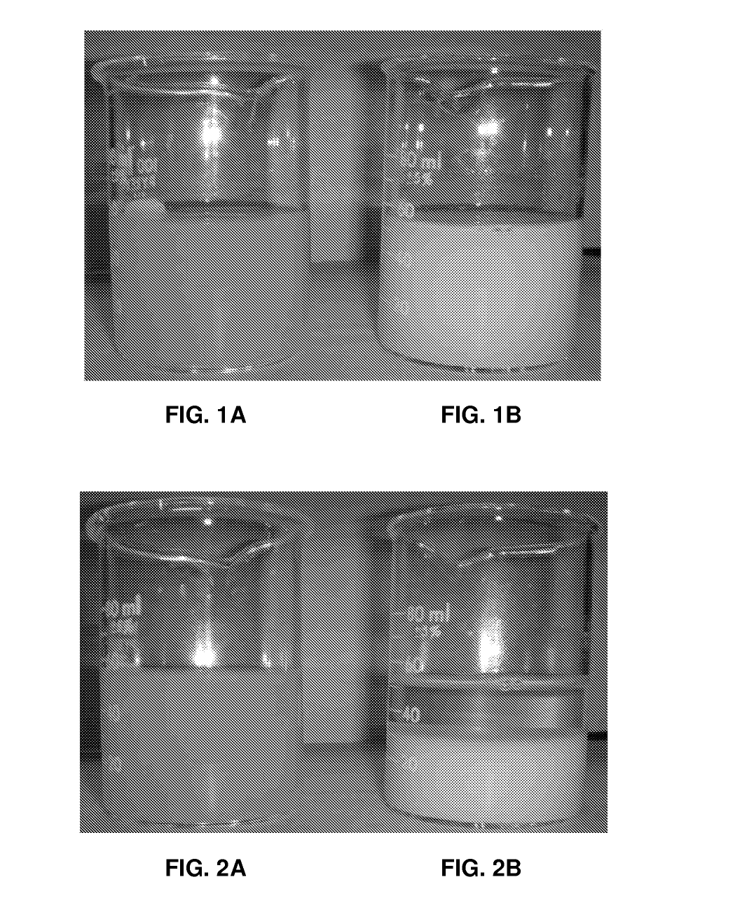

As a clay expanding test, 50 mls of both Fluid A and Fluid B were stirred in glass beakers for two minutes, and then they were left to settle without further agitation. Photographs were taken at time intervals. FIG. 1 herein presents both beakers immediately after stirring with Fluid A (without nanoparticles) on the left side (FIG. 1A) and Fluid B (with nanoparticles) on the right side (FIG. 1B). From this photograph, it may be seen that all particles are still dispersed in both Fluids A and B immediately after mixing.

The photograph in FIG. 2 was taken 20 minutes after stirring ceased. There is already a dramatic difference between the two fluids. Fluid A on the left in FIG. 2A shows that the suspended clay particles are still uniformly dispersed throughout the Fluid A, whereas Fluid B containing the nanoparticles in FIG. 2B on the right demonstrates that all particles are beginning to settle out.

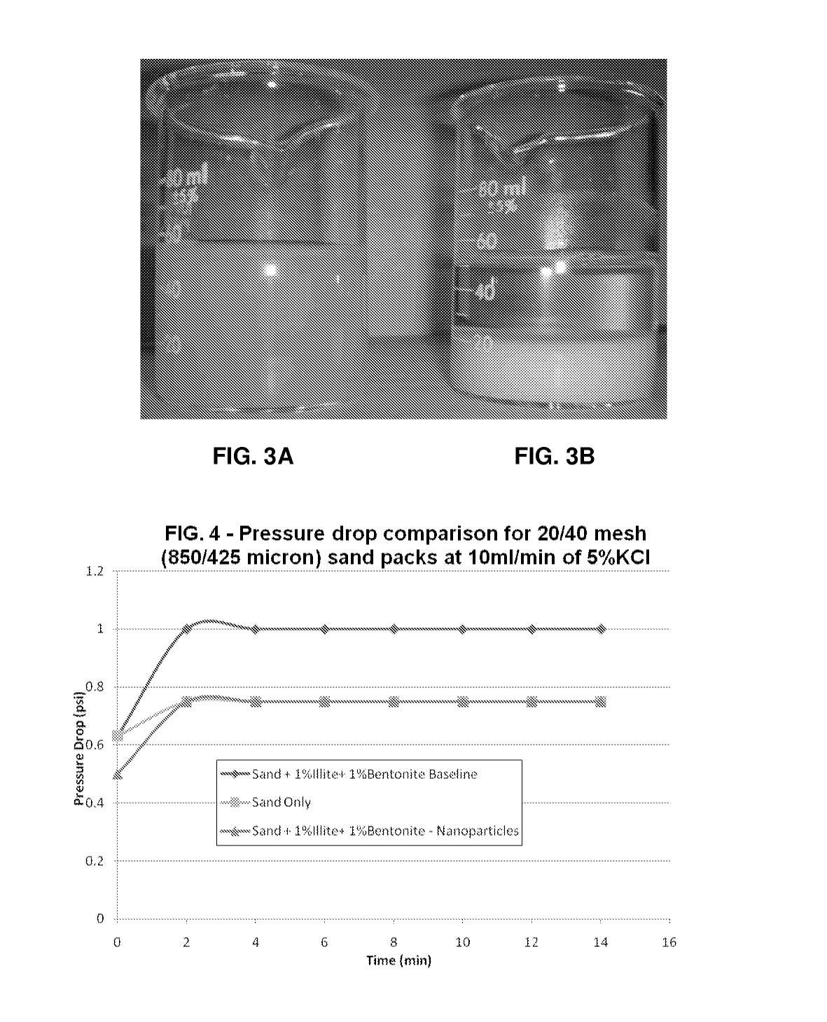

The photograph in FIG. 3 was taken 60 minutes (1 hour) after stirring ceased. It may be seen that the suspended clay particles in Fluid A on the left in FIG. 3A are still uniformly dispersed, whereas all of the particles in Fluid B containing the nanoparticles, shown on the right in FIG. 3B have completely settled out. Example 1 thus demonstrates that the nanoparticles in Fluid B inhibited the clay particles from expanding and remaining dispersed in the fluid.

### Example 2

20/40 mesh (850/425 micron) sand alone, the sand mixed with 1% bw bentonite and 1% bw illite, and the sand mixture of with 1% bw bentonite and 1% bw illite containing 0.4% bw nanoparticles were vertically packed in separate one-inch (2.54 cm) ID and 12-inch (30.48 cm) long acrylic tubes with 100 mesh screens at both ends. The acrylic tube has a 0.125 inch (3.2 mm) outlet orifice at each end. A separate pressure differential transducer was mounted at both ends of each tube. 5% bw KCl water was pumped at 10 ml/min through each pack and each pressure differential was recorded. The D₅₀ of the bentonite is 39 microns and D₉₀ 142 microns. The D₅₀ of the illite is 16 microns and D₉₀ 90 microns.

The sand pack tests were conducted and demonstrated that the pressure drop of 5% bw KCl water flowing through the pack containing 0.4% bw nanoparticles (magnesium oxide with an average particle size of 35 nm) is much lower than that of the same sand pack containing no nanoparticles at the same flow rate, and is almost the same as a pack having only sand. Both sand packs contain the same amount of natural bentonite and illite (1 percent bentonite and 1 percent illite). These results are shown in FIG. 4.

### Example 3

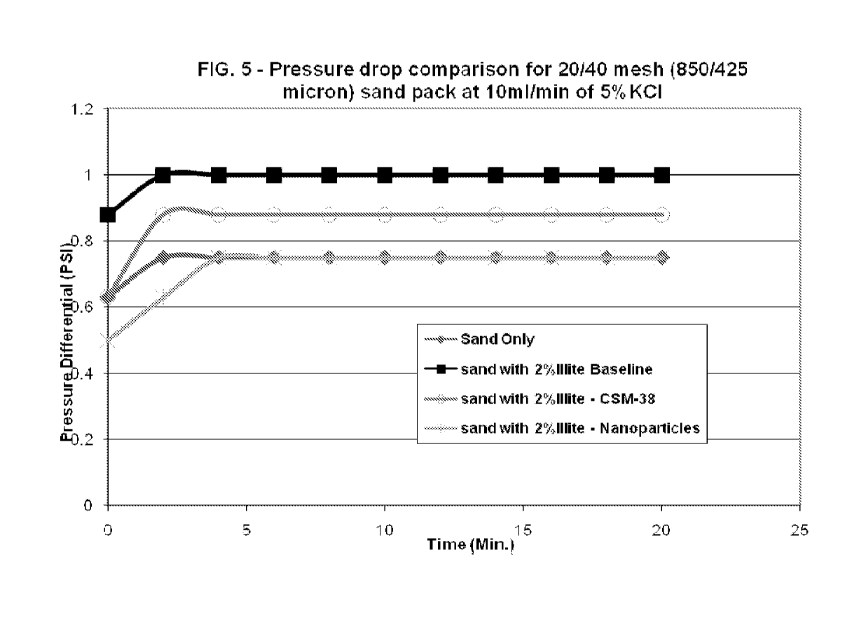

Similar sand packs were made as Example 2. FIG. 5 shows the similar results as FIG. 4 for the sand packs containing 2% bw illite with and without 0.4% bw nanoparticles. FIG. 5 also shows that the pressure drop of 5% bw KCl water flowing through the pack containing 0.4% bw nanoparticles (magnesium oxide with an average particle size of 35 nm) is lower than that of 5% bw KCl and 2% bw CSM-38 (a polyquat amine based clay control additive from CESI Chemical) solution flowing through the same sand pack containing no nanoparticles at the same flow rate.

### Example 4

Rev Dust, a natural mixture of clays and fines, was used to replace bentonite and illite in Example 2 and 3 for sand pack tests. The D₅₀ of the Rev Dust is 18 microns and D₉₀ 60 microns. It contains 12% quartz, 7% cristobalite, 4% illite, 29% mixed layers (bentonite), 26% kaolinite, and 22% chlorite. 2% bw Rev Dust was mixed with 20/40 mesh (850/425 micron) sand with and without 0.4% nanoparticles to build 12-inch long sand packs. 5% bw KCl water was pumped through the packs at different flow rates and pressure drops were recorded accordingly in the following Table I, which shows that the pressure drop of sand pack with nanoparticles is lower than that of sand pack without nanoparticles.

TABLE I

| | Pressure Drop, psi (KPa) | | | |
|---|---|---|---|---|
| | 2 ml/min | 5 ml/min | 10 ml/min | 15 ml/min |
| With nano | 0.71 | 0.76 | 0.84 | 0.94 |
| | (4.9) | (5.2) | (5.8) | (6.5) |
| Without nano | 0.78 | 0.84 | 0.95 | 1.09 |
| | (5.4) | (5.8) | (6.6) | (7.5) |

In the foregoing specification, it will be evident that various modifications and changes may be made thereto without departing from the broader spirit or scope of the invention as set forth in the appended claims. Accordingly, the specification is to be regarded in an illustrative rather than a restrictive sense. For example, specific combinations of alkaline earth metal oxides, alkaline earth metal hydroxides, alkali metal oxides, alkali metal hydroxides, transition metal oxides, transition metal hydroxides, post-transition metal oxides, post-transition metal hydroxides, piezoelectric crystals, and pyroelectric crystals, of various sizes, brines, and other components falling within the claimed parameters, but not specifically identified or tried in a particular method or composition, are anticipated to be within the scope of this invention.

The present invention may suitably comprise, consist or consist essentially of the elements disclosed and may be practiced in the absence of an element not disclosed.

The words “comprising” and “comprises” as used throughout the claims is to interpreted “including but not limited to”.

What is claimed is:

1. A method for stabilizing clays comprising introducing into a subterranean formation containing clays a treating fluid comprising:
a base fluid, and
an amount of a particulate additive effective to stabilize the clays, the particulate additive:
having a mean particle size of 100 nm or less, and
being selected from the group consisting of alkaline earth metal oxides, alkaline earth metal hydroxides, alkali metal oxides, alkali metal hydroxides, transition metal oxides, transition metal hydroxides, post-transition metal oxides, post-transition metal hydroxides, piezoelectric crystals, pyroelectric crystals, and mixtures thereof,
where the clays in the formation are inhibited from expansion and/or migration as compared with introducing an identical fluid absent the particulate additive.

2. The method of claim 1 where the base fluid is selected from the group consisting of water, brine, oil, alcohol, and mixtures thereof.

3. The method of claim 1 where:
the alkaline earth metal is selected from the group consisting of magnesium, calcium, strontium, and barium,
the alkali metal is selected from the group consisting of lithium, sodium, and potassium,
the transition metal is selected from the group consisting of titanium and zinc, and
the post-transition metal is aluminum, and mixtures thereof.

4. The method of claim 1 where the effective amount of the particulate additive ranges from about 2 to about 300 pptg (about 0.24 to about 36 kg/1000 liters) based on the treating fluid.

5. The method of claim 1 further comprising treating the subterranean formation by a process selected from the group consisting of:
fracturing the formation under effective pressure where the treating fluid further comprises a proppant;
acidizing the formation where the treating fluid further comprises an acid;
packing the formation with gravel where the treating fluid further comprises gravel;
completing a well; and
controlling fluid loss where the treating fluid further comprises a salt or easily removed solid; and mixtures thereof.

6. The method of claim 1 where the mean particle size of the particulate additive is 90 nm or less.

7. A method for stabilizing clays comprising introducing into a subterranean formation containing clays an aqueous treating fluid comprising:
an aqueous base fluid, and
an amount of a particulate additive effective to stabilize the clays, the particulate additive:
having a mean particle size of 100 nm or less, and
being selected from the group consisting of alkaline earth metal oxides, alkaline earth metal hydroxides, alkali metal oxides, alkali metal hydroxides, transition metal oxides, transition metal hydroxides, post-transition metal oxides, post-transition metal hydroxides, piezoelectric crystals, pyroelectric crystals, and mixtures thereof, where:
the alkaline earth metal is selected from the group consisting of magnesium, calcium, strontium, and barium,
the alkali metal is selected from the group consisting of lithium, sodium, and potassium,
the transition metal is selected from the group consisting of titanium and zinc, and
the post-transition metal is aluminum, and mixtures thereof;
where the clays in the formation are inhibited from expansion and/or migration as compared with introducing an identical fluid absent the particulate additive.

8. The method of claim 7 where the effective amount of the particulate additive ranges from about 2 to about 300 pptg (about 0.24 to about 36 kg/1000 liters) based on the treating fluid.

9. The method of claim 7 further comprising treating the subterranean formation by a process selected from the group consisting of:
fracturing the formation under effective pressure where the aqueous treating fluid further comprises a proppant;
acidizing the formation where the aqueous treating fluid further comprises an acid;
packing the formation with gravel where the aqueous treating fluid further comprises gravel;
completing a well; and
controlling fluid loss where the aqueous treating fluid further comprises a salt or easily removed solid; and mixtures thereof.

10. The method of claim 1 where the mean particle size of the particulate additive is 90 nm or less.

11. A method for stabilizing clays comprising introducing into a subterranean formation containing clays a treating fluid comprising:
a base fluid, and
from about 2 to about 300 pptg (about 0.24 to about 36 kg/1000 liters) based on the treating fluid of a particulate additive effective to stabilize the clays, the particulate additive:
having a mean particle size of 90 nm or less, and
being selected from the group consisting of alkaline earth metal oxides, alkaline earth metal hydroxides, alkali metal oxides, alkali metal hydroxides, transition metal oxides, transition metal hydroxides, post-transition metal oxides, post-transition metal hydroxides, piezoelectric crystals, pyroelectric crystals, and mixtures thereof,
where the clays in the formation are inhibited from expansion and/or migration as compared with introducing an identical fluid absent the particulate additive.

12. The method of claim 11 where the base fluid is selected from the group consisting of water, brine, oil, alcohol, and mixtures thereof.

13. The method of claim 11 where:
the alkaline earth metal is selected from the group consisting of magnesium, calcium, strontium, and barium,
the alkali metal is selected from the group consisting of lithium, sodium, and potassium,
the transition metal is selected from the group consisting of titanium and zinc, and
the post-transition metal is aluminum, and mixtures thereof.

14. The method of claim 11 further comprising treating the subterranean formation by a process selected from the group consisting of:
fracturing the formation under effective pressure where the treating fluid further comprises a proppant;
acidizing the formation where the treating fluid further comprises an acid;
packing the formation with gravel where the treating fluid further comprises gravel;
completing a well; and
controlling fluid loss where the treating fluid further comprises a salt or easily removed solid; and mixtures thereof.
